(19) United States
(12) Patent Application Publication
(10) Pub. No.: US 2008/0172510 A1
(43) Pub. Date: Jul. 17, 2008

(54) PARALLEL BUS ARCHITECTURE AND RELATED METHOD FOR INTERCONNECTING SUB-SYSTEMS UTILIZING A PARALLEL BUS

(76) Inventor: Wei-Jen Chen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/623,325

(22) Filed: Jan. 16, 2007

(51) Int. Cl. G06F 13/14; G06F 13/38

(52) U.S. Cl. 710/242

(57) ABSTRACT

A parallel bus architecture is disclosed. The parallel bus architecture includes: a first sub-system comprising at least a first master device and at least a first slave device, wherein the first master device can access the first slave directly; a second sub-system comprising at least a second master device and at least a second slave device, wherein the second master device can access the second slave directly; and an interconnect matrix, coupled to the first sub-system and the second sub-system, for transmitting a command from the first sub-system to the second sub-system and transmitting a command from the second sub-system to the first sub-system.

### BACKGROUND OF THE INVENTION

1. Field of the Invention

The present invention relates to bus architectures, and more particularly, to a bus system utilizing a parallel architecture.

2. Description of the Prior Art

The simplest bus system consists of a single master device for controlling a single slave device. FIG. 1 is a diagram of a single bus architecture 100 where all components share a single bus 102. The single bus architecture 100 comprises three master devices 110, 120, 130, and four slave devices 150, 160, 170, 180. As the number of master devices and slave devices increases, the system becomes increasingly more complicated. An arbiter 140 is included for arbitrating access to the bus 102. Although the connection is simple, and the command routes are not complex, overloading of master devices and slave devices results in a slow bus clock rate, and performance degradation as the bus 102 is overloaded.

To reduce the load problem, manufacturers designed an architecture that consists of a series of buses, arranged according to hierarchy. FIG. 2 is a diagram of an exemplary hierarchical bus architecture 200. The hierarchical bus architecture 200 comprises four first level master devices 212, 214, 216, 218 (M₁-M₄) coupled to buses 202a and 202b; one second level master device 232 (M₅) coupled to a bus 204; and two third level masters 242, 244 (M₆ and M₇) coupled to a bus 206. The hierarchical bus architecture 200 further comprises: four first level slave devices 222, 224, 226, 228 (S₁-S₄) coupled to the buses 202a and 202b respectively; two second level slave devices 234, 236 (S₅ and S₆); and four third level slave devices 252, 254, 256, 258 (S₇-S₁₀). For enabling access between separate level buses 202a, 202b, 204, 206, the hierarchical bus architecture 200 further comprises two first level bridge devices 210, 220 (Bᵣ₁ and Bᵣ₂); and one second level bridge device 230 (Bᵣ₃). Global resources are situated on a lower hierarchy level to allow access by corresponding master devices, for example, if the slave device 258 is shared by master devices 212, 232 and 244, it must be situated on the third level. Generally speaking, those slave devices frequently accessed are situated on a higher hierarchy level, and those less frequently accessed are situated on a lower hierarchy level. The advantage of this system is that a split bus consumes less power than a single bus. The disadvantage, however, is that the use of different hierarchies restricts the flexibility of the system: for example, a lower hierarchy level master device (e.g. M₆) cannot control a higher hierarchy level slave (e.g. S₂), and furthermore, a master cannot control a slave that has the same hierarchy but is situated on a separate bus (e.g. M₂ cannot control S₃). As the hierarchical bus architecture 200 is arranged in levels, when a highest order master determines to access a lowest order slave (e.g. M₃ determines to access S₈) all bus levels in between will be occupied.

In order to compensate for the disadvantages of the above-mentioned system, manufacturers designed a multi-layer architecture that uses an interconnect matrix for facilitating commands between master devices and slave devices. FIG. 3 is a diagram of an exemplary multi-layer bus architecture 300. A first master device and a second master device 310 and 320 respectively are situated on one side of the interconnect matrix 330, for controlling a first slave device and a second slave device 370 and 380 respectively that are situated on the other side of the interconnect matrix 330. Each master device can access each slave device by utilizing the interconnect matrix 330. The interconnect matrix 330 comprises four command routes, two for each master device. The interconnect matrix 330 has two input stages 334 and 354 for receiving commands from the first master device 310 and the second master device 320 respectively. The commands will then be respectively passed on to a first multiplexer (MUX) and a second multiplexer (MUX) 336, 356 which further receive an input from a first decoder and a second decoder 332, 352 for determining which slave device the master device 310, 320 desires to access. These commands will then be passed on to a third MUX and a fourth MUX 344, 364 respectively, for selectively accessing the first slave device 370 or the second slave device 380. The third MUX and fourth MUX 344, 264 further receive an input from a first arbiter and a second arbiter 342, 362 respectively, for arbitrating access to the first slave device and the second slave device 370, 380. The advantage of the system is that each master device can access each slave device, and the system is therefore far more flexible than the related art single bus architecture 100, and hierarchical bus architecture 200. The system entails heavy overhead, however, as each slave device requires an arbiter. Furthermore, the routing is complex.

### SUMMARY OF THE INVENTION

It is therefore an objective of the present invention to provide a new bus archtiecture to solve the problems of the related art.

Briefly described, a parallel bus architecture is provided. The bus system comprises: a first sub-system comprising a first master device and a first slave device, wherein the first master device can access the first slave directly; a second sub-system comprising a second master device and a second slave device, wherein the second master device can access the second slave directly; and an interconnect matrix, coupled to the first sub-system and the second sub-system, for transmitting a command from the first sub-system to the second sub-system and transmitting a command from the second sub-system to the first sub-system.

A method for interconnecting sub-systems is further provided. The method comprises: providing a first sub-system with a first master device and a first slave device, wherein the first master device can access the first slave directly; providing a second sub-system comprising a second master device and a second slave device, wherein the second master device can access the second slave directly; transmitting a command from the first sub-system to the second sub-system; and transmitting a command from the second sub-system to the first sub-system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a single bus architecture according to the related art.

FIG. 2 is a diagram of a hierarchical bus architecture according to the related art.

FIG. 3 is a diagram of a multi-layer bus architecture according to the related art.

FIG. 4 is a diagram of a parallel bus architecture according to a first embodiment of the present invention.

FIG. 5 is a diagram of a parallel bus architecture according to a second embodiment of the present invention.

FIG. 6 is a diagram of a parallel bus architecture according to a third embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. In addition, the term “couple” is intended to mean either an indirect or a direct electrical connection. Accordingly, if one device is coupled to another device, that connection may be through a direct electrical connection, or through an indirect electrical connection via other devices and connections.

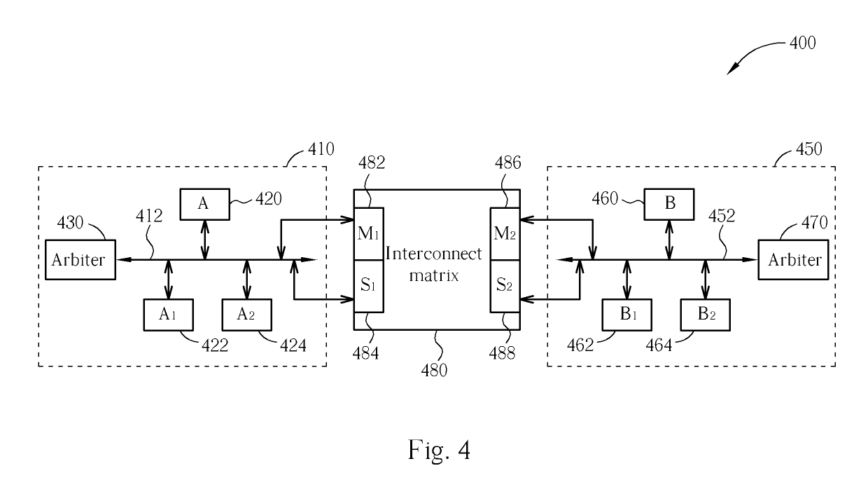

Please refer to FIG. 4. FIG. 4 is a diagram of a parallel bus architecture 400 according to a first embodiment of the present invention. The parallel bus architecture 400 comprises an interconnect matrix 480, a first sub-system 410, and a second sub-system 450. The first sub-system 410 consists of a master device 420 (A), and two slave devices 422, 424 (A₁ and A₂), connected via a single bus 412. The second sub-system 450 similarly consists of a master device 460 (B) and two slave devices 462, 464 (B₁ and B₂), connected via a single bus 452. The first sub-system 410 and the second sub-system 450 further comprise an arbiter 430, 470 respectively. In this embodiment, the interconnect matrix 480 comprises a first master port 482 (M₁) and a first slave port 484 (S₁) coupled to the first sub-system 410, and a second master port 486 (M₂) and a second slave port 488 (S₂) coupled to the second sub-system 450. Please note that the number of master devices and slave devices of each sub-system shown in the diagram are merely an embodiment of the present invention, and not a limitation. Any number of master devices and slave devices that can comprise a single bus can be utilized on any one sub-system, and this still obeys the spirit of the present invention.

In general, the master device 420 on the first sub-system 410 usually controls the slave devices 422, 424 on the first sub-system 410. In such a case, the first sub-system 410 operates as a single bus architecture. If, however, the master device 420 wishes to access a slave device on the second sub-system 450, the master device 420 needs to send a command message through the interconnect matrix 480. This is achieved by utilizing the ports on the interconnect matrix 480. The master device 420 will send a command message to the first slave port 484 which passes the command message through the interconnect matrix 480 to the second master port 486. The second master port 486 then passes the command message to the bus 452 to access the desired slave device (e.g. B₂) on the second sub-system 450. The return signal is sent back in the same way (from the desired slave device [e.g. B₂] to the second master port 486 to the first slave port 484 to the master device 420). Therefore, each communication is from a master device to a slave device and vice versa. A situation may occur wherein the master device 420 wishes to access a slave device on the second sub-system 450, and the second sub-system 450 wishes to access a slave device on the first sub-system 410. This can create a ‘dead-lock’ problem where both sub-systems are waiting for an arbitration request to be granted, i.e. because both sub-systems occupy the same hierarchical level, neither master has priority over the other. For example, if the master device 460 (B) wishes to access slave device 422 (A₁), and the master device 420 (A) wishes to access slave device 462 (B₁) at the same time, an arbiter (not shown) in the interconnect matrix must grant priority to one of the master devices. If authority is granted to master device 460, for example, the master device A must wait to gain access to the slave device B₁, but the master device B cannot gain access to the slave device A₁, because the master device A still has authority of the bus 412. Both sub-systems therefore remain in a perpetual waiting state. To avoid this problem, the arbiter in the interconnect matrix can first send information to the master device A, instructing it to remove the authority of the bus 412, thereby allowing the master device A to access the bus 412. Once this access is completed, the arbiter in the interconnect matrix can then instruct the arbiter 430 to re-grant authority of the bus 412 to the master device A, and allow it to access the bus 452.

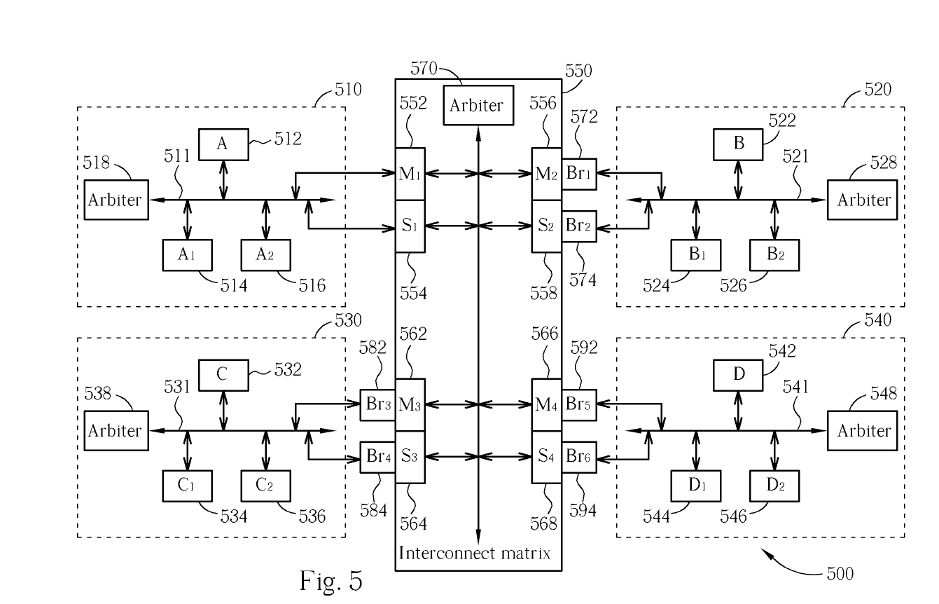

Please note that, in the above-mentioned interconnect matrix 480, the connection between the first slave port 484 and the second master port 486, and the connection between the second slave port 488 and the first master port 482 acts as a single bus respectively. The parallel bus architecture 400 described above is the simplest embodiment of the present invention. If more sub-systems are required, however, the disclosed parallel bus architecture 400 can advantageously enable a first master device to control a slave device on any other sub-system. FIG. 5 is a diagram of a disclosed interconnect matrix 550, comprising four sub-systems 510, 520, 530, 540. Each sub-system has an equal hierarchy with other sub-systems. Furthermore, each sub-system acts as a separate single bus system. Please note that the interconnect matrix 550 in this embodiment can similarly act like a single bus architecture, wherein only one master device is allowed to access a specific slave device at any one time, or can be constructed as a multi-layer bus architecture, wherein the interconnect matrix 550 can support multiple access requests. In this case, the interconnect matrix 550 comprises an arbiter 570, enabling it to arbitrate commands to a particular sub-system according to priority. That is, the interconnect matrix 550 is able to arbitrate access between master ports 552, 556, 562, 566 (M₁-M₄), and slave ports 554, 558, 564, 568 (S₁-S₄). In addition, the interconnect matrix could be an on chip device or an off chip device according to design requirements.

If, for example, master device 512 and master device 532 wish to access a slave device on the second sub-system 520, the commands will be sent through the first slave port 554 and the third slave port 564 respectively to the second master port 556. The arbiter 570, coupled to the second master port 556, will arbitrate the commands and send them to the second sub-system 520 one at a time. Additionally, each sub-system 510, 520, 530, 540 further comprises an arbiter 518, 528, 538, 548 respectively coupled to the bus 511, 521, 531, 541 of each sub-system 510, 520, 530, 540 (as in the previous description), for arbitrating commands received along the bus 511, 521, 531, 541.

A further advantage of the present invention is that it can enable operation between sub-systems having different protocols, for example a different operating frequency. This can be achieved by adding a bridge 572, 574, 582, 584, 592, 594 (Br₁-Br₆) to each port connection in the interconnect matrix 550. Please note that in FIG. 5 the first sub-system 510 does not comprise a bridge; this is merely one embodiment, however, and not a limitation of the present invention. The commands that are propagated in the interconnect matrix 550 have a particular operating frequency, but can be altered to match that of a sub-system by the utilization of the bridge. Therefore, the present invention enables sub-systems from different manufacturers to be connected together.

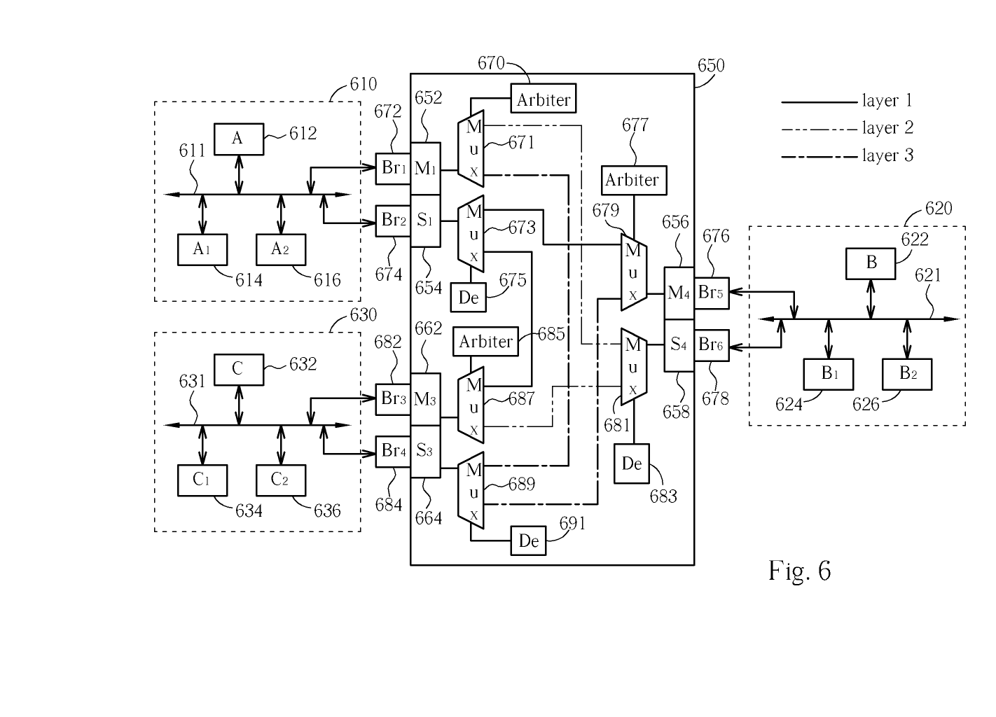

Please note that the architecture of the interconnect matrix is not limited to the single bus architecture shown in FIG. 5. FIG. 6 is a diagram of an interconnect matrix 650 according to a third embodiment of the present invention. The interconnect matrix 650 is coupled to three sub-systems, 610, 620, and 630 respectively. The first sub-system 610 is coupled to the interconnect matrix 650 through bridges 672 and 674 (Br₁ and Br₂). The second sub-system 620 is coupled to the interconnect matrix 650 through bridges 676 and 678 (Br₅ and Br₆). The third sub-system 630 is coupled to the interconnect matrix 650 through bridges 682 and 684 (Br₃ and Br₄). The interconnect matrix 650 comprises three layers. A first layer couples the slave port 654 of the first sub-system 610 to the master port 656 of the second sub-system 620 and the master port 662 of the third sub-system 630 through multiplexers 679 and 687 respectively. A second layer couples the master port 652 of the first sub-system to the slave port 658 of the second sub-system through the multiplexer 681. The second layer also couples the master port 662 of the third sub-system to the slave port 658 of the second sub-system through the multiplexer 681. The third layer couples the master port 652 of the first sub-system to the slave port 664 of the third sub-system through the multiplexer 689. The third layer also couples the master port 656 of the second sub-system to the slave port 664 of the third sub-system through the multiplexer 689. It should be noted that this is merely one example of an interconnect matrix having a multi layer architecture, and other multi layer architectures also fall within the scope of the present invention.

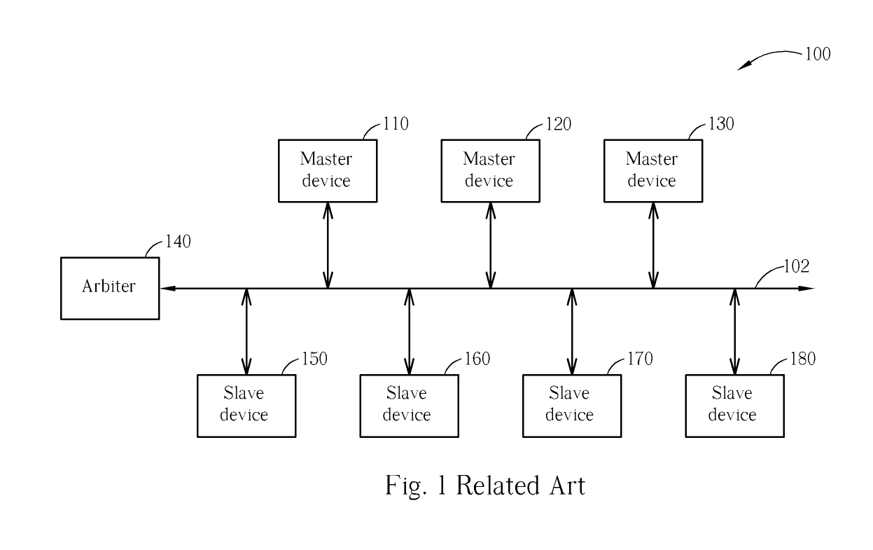

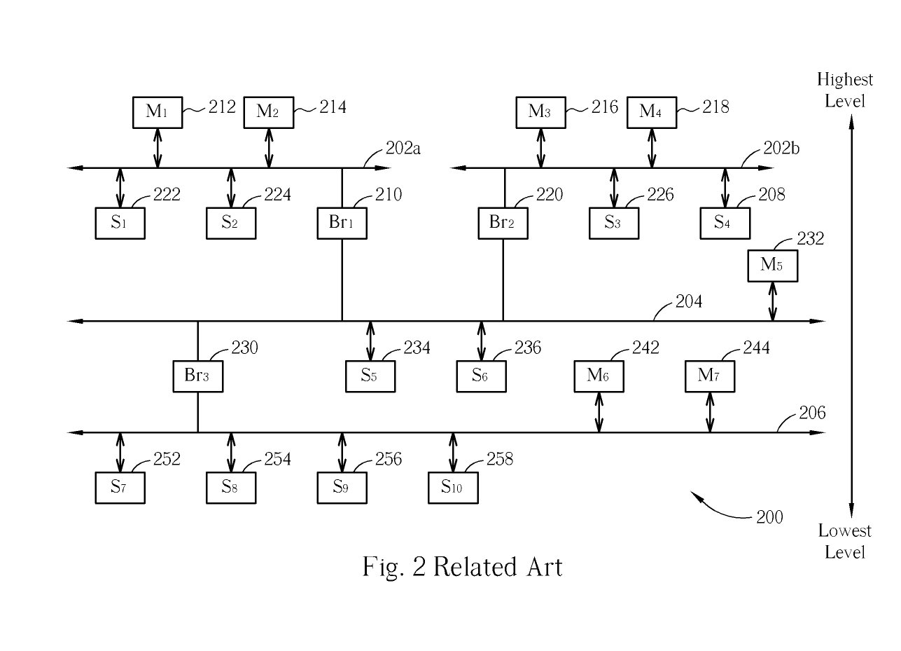

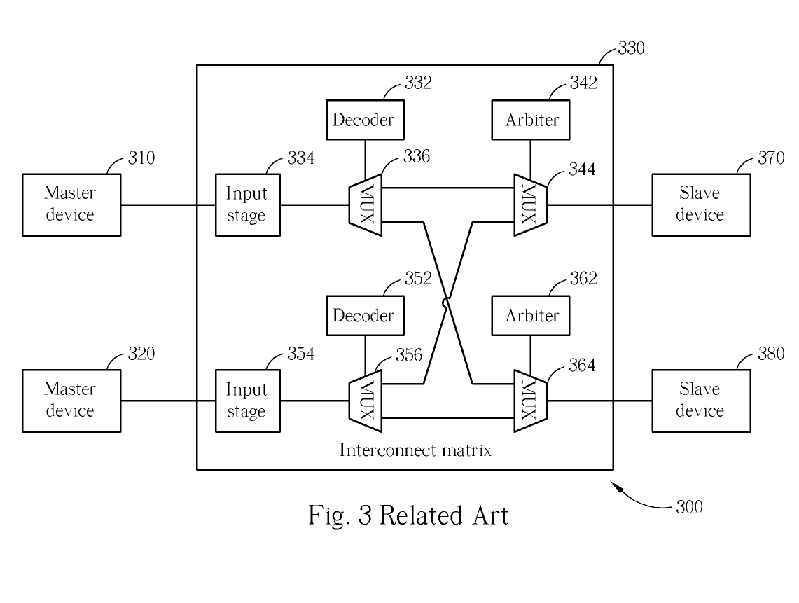

In order to better illustrate the working of the disclosed interconnect matrix 480, 550, various operations will be detailed below with reference to prior art solutions and the solution enabled by the present disclosure. Please refer to FIGS. 1-5. In a first situation where each master device most frequently accesses the slave devices coupled to the same sub-system, the single bus architecture 100 will have high bus conflict, from all the components operating along the same bus line. The hierarchical bus architecture 200 will incur longer latency, as the master devices will have to access lower level buses and go through the bridges, thereby occupying all buses on hierarchical levels between the master device and the desired slave device. Furthermore, on lower hierarchical level buses, there will also be conflict. The multi-layer bus architecture 300 requires multiplexers 336, 344, 356, 364 between each master device and slave device, and therefore the clock rate is significantly slowed. The disclosed parallel bus architecture 400, 500, however, enables each sub-system to operate as a separate system without affecting the operation of other sub-systems when master devices are accessing slave devices on the same sub-systems, and further enables the operation to be performed at the maximum clock rate of each sub-system.

In a case where a slave device has a different protocol from a master device, a bridge connection is required between the master device and the slave device. The multi-layer bus architecture 300 will require a bridge between each possible master-slave operating path, or between each multiplexer and slave. In the first case, the number of bridges needed is very high; in the second case, the latency is significantly long on a frequently accessed path.

In the case where a first sub-system wishes to access a second sub-system, the hierarchical bus architecture 200 will have to utilize a master device to first access a lower level memory, which then interrupts the master device on the desired bus to access a desired slave device. The result is then written to the lower level memory, which itself interrupts the original master device to enable it to obtain the result. There is high communication overhead. The multi-layer bus architecture 300 involves complex interconnection. The parallel bus architecture 400, 500 of the present disclosure, however, allows reduced processor overhead, and a less complex operating procedure for obtaining the same results.

It can therefore be seen that the disclosed parallel bus architecture 400, 500 enables a specific sub-system to access a separate sub-system without incurring heavy overhead, significant latency, or requiring complex circuitry. It is a further advantage of the disclosed architecture that sub-systems utilizing separate protocols can be utilized, without requiring modification of the sub-system interconnection. Moreover, every slave can be accessed by every master in the architecture, and there is no hierarchy level constraint.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A parallel bus architecture, comprising:
a first sub-system comprising a first master device and a first slave device, wherein the first master device can access the first slave directly;
a second sub-system comprising a second master device and a second slave device, wherein the second master device can access the second slave directly; and
an interconnect matrix, coupled to the first sub-system and the second sub-system, for transmitting a command from the first sub-system to the second sub-system and transmitting a command from the second sub-system to the first sub-system.

2. The parallel bus architecture of claim 1, wherein the interconnect matrix comprises:
a first master port, coupled to the first sub-system, for receiving a command from the second sub-system and transmitting the command to the first sub-system;
a first slave port, coupled to the first sub-system, for transmitting a command from the first sub-system to the second sub-system;
a second master port, coupled to the second sub-system, for receiving a command from the first sub-system and transmitting the command to the second sub-system; and
a second slave port, coupled to the second sub-system, for transmitting a command from the second sub-system to the first sub-system.

3. The parallel bus architecture of claim 2 wherein the first master device sends commands to the second slave device via the first slave port and the second master port; and the second master device sends commands to the first slave device via the second slave port and the first master port.

4. The parallel bus architecture of claim 1, wherein the first sub-system and the second bus sub-system further comprise an arbiter respectively.

5. The parallel bus architecture of claim 2, further comprising:
a third sub-system comprising a third master device and a third slave device, wherein the third master device can access the third slave directly;
wherein the interconnect matrix further comprises:
a third master port, coupled to the third sub-system, for receiving a command from the first sub-system or the second sub-system and transmitting the command to the third sub-system;
a third slave port, coupled to the third sub-system, for transmitting a command from the third sub-system to the first sub-system or the second sub-system; and
an arbiter, coupled to the first master port, the first slave port, the second master port, the second slave port, the third master port, and the third slave port, for arbitrating access between ports.

6. The parallel bus architecture of claim 1, wherein the interconnect matrix is an on chip device.

7. The parallel bus architecture of claim 1, wherein the interconnect matrix is an off chip device.

8. The parallel bus architecture of claim 2, further comprising:
a first bridge, coupled to the first master port, for changing the operating frequency of a command received from the second sub-system; and
a second bridge, coupled to the first slave port, for changing the operating frequency of a command transmitted from the first sub-system.

9. A method for interconnecting sub-systems utilizing a parallel bus, comprising:
providing a first sub-system with a first master device and a first slave device, wherein the first master device can access the first slave directly;
providing a second sub-system comprising a second master device and a second slave device, wherein the second master device can access the second slave directly;
transmitting a command from the first sub-system to the second sub-system; and
transmitting a command from the second sub-system to the first sub-system.

10. The method of claim 9, wherein the steps of transmitting a command from the first sub-system to the second sub-system and transmitting a command from the second sub-system to the first sub-system further comprise:
arbitrating the commands.

11. The method of claim 9, further comprising:
providing a third sub-system with a third master device and a third slave device, wherein the third master device can access the third slave directly;
transmitting a command from the third sub-system to the first sub-system or the second sub-system;
transmitting a command from the first sub-system or the second sub-system to the third sub-system; and
arbitrating commands between the first sub-system, the second sub-system, and the third sub-system.

12. The method of claim 9, wherein the steps of transmitting a command from the first sub-system to the second sub-system, and transmitting a command from the second sub-system to the first sub-system further comprise:
changing the operating frequency of the command.
